(19) United States
(12) Patent Application Publication
(10) Pub. No.: US 2003/0188189 A1
(43) Pub. Date: Oct. 2, 2003

(54) Multi-level and multi-platform intrusion detection and response system

(76) Inventors: Anish P. Desai, Fairfax, VA (US); Yuan John Jiang, Reston, VA (US); William C. Tarkington, Fairfax, VA (US); Jeff P. Oliveto, Oak Hill, VA (US)

Correspondence Address: Raymond C. Jones, Esq., 43787 Bent Creek Terrace, Leesburg, VA, 20176, US

(21) Appl. No.: 10/106,387

(22) Filed: Mar. 27, 2002

(51) Int. Cl. H04L 9/00

(52) U.S. Cl. 713/201

(57) ABSTRACT

An intrusion detection and response system having an event data collector receiving a plurality of data sets from a respective and corresponding plurality of security devices. An event analysis engine receives the plurality of data sets and analyzes the data sets with reference to one of a plurality of pre-defined traffic classes. The event analysis engine produces a corresponding plurality of analyzed data sets. An event correlation engine receives the analyzed data sets and correlates the events across the plurality of security devices for identifying normal and abnormal data traffic patterns.

### BACKGROUND OF THE INVENTION

1. Field of the Invention

The present invention relates to a comprehensive intrusion detection solution, combining, (i) near real-time log-based monitoring utilizing variable behavior based attack signatures for multiple platform devices (e.g., firewalls, routers, switches, virtual private network appliances, computer systems, etc.), and (ii) network or host based intrusion detection systems that utilize knowledge-based attack signatures, with the capability to correlate security events across a variety of platforms from leading vendors.

2. Description of the Related Art

The Internet is rapidly evolving, and more businesses are using the Internet as a resource to expand their networking capabilities. As a result, Internet security and Internet privacy are issues that have attracted the attention of all who use and maintain computer networks. From Internet vandals unleashing DDoS (Distributed Denial of Service) attacks on major websites, to the Code Red, Nimda and ‘I Love You’ viruses, almost all attacks on computer networks can be mitigated, if not prevented, if system administrators take the appropriate steps to secure and monitor their networks. The Internet vandals probing networks for security vulnerabilities may be curious teenagers, disgruntled employees, or corporate criminals from rival companies. The process of detecting and preventing security breaches by monitoring user and application activity is broadly known as intrusion detection.

Intrusion detection systems (IDS) actively monitor operating system activity and network traffic for attacks and breaches. The goal is to provide a near-real-time view of the traffic patterns on the network. There are three general approaches to intrusion detection:

Network-based systems “sniff” the wire, comparing live traffic patterns to a list of known attack patterns

Host-based systems use software “agents” that are installed on all servers and report activity to a central console

Log-based systems send error and event logs to a central server for analysis for abnormal behavior

Note that network-based IDS require a regularly updated list of known attacks, similar to that employed for anti-virus software.

Intrusion detection is a proactive process requiring continuous attention by system administrators. In order to remain secure, Information Technology (IT) systems must be frequently updated to guard against newly discovered security weaknesses. Intrusion detection is important because of the difficulty in keeping up with the rapid pace of potential threats to computer systems.

Usually, unauthorized access is gained by exploiting operating system vulnerabilities, that is, unintended flaws in installed software. This can be done in a number of ways. For example, when an attacker chooses a target, they can execute software to determine the remote operating system, search various underground websites for flaws in that particular operating system, and then execute scripts that exploit the victim system. Virtually all server attacks progress in this systematic manner. Intrusion detection tools help system administrators stop network attacks and aid in tracking down the attackers.

Intrusion detection systems can be designed to stop both internal and external attacks on a corporate computer network, providing the network administrator with the ability to monitor, detect and prevent intrusions and misuse of valuable networks, systems, and the data stored on those systems. Many devices are vulnerable to attack. As used hereafter, the term “device” is used generically to encompass all types of security devices, including, but not limited to the following: firewalls, virtual private networks (VPNs), intrusion detection systems, network systems such as routers and switches, and host systems, such as web servers, network servers, workstations, operating systems, and the like.

These security devices are designed to restrict or control access to a specific set of resources. Often these devices are equipped with a logging mechanism to indicate success and failure to the specified resources. For the purposes of this description, such logs are referred to as “event logs”, or the particular device has an “event logging capability”.

Unfortunately, while these event logs contain valuable operational and historical information, they are routinely neglected due to their volume and complexity. Manual scanning of hundreds of megabytes, or at times gigabytes, of logs on a daily basis is tedious and error prone, and requires a huge personnel and computational resource commitment to review them on a timely basis. Typically, the logs are reviewed only after a security incident occurs, to investigate how a resource was breached. Moreover, it is nearly impossible detect the trends and correlation that might exist in the data because of the inherent limitations in manually scanning the logs. Automated tools are being developed to lower the relative amount of resources required to monitor security devices, although there is still a high resource commitment required.

Despite these shortcomings and limitations, the event logs could be a valuable resource in both visibility and classification of malicious activity, if they could be analyzed correctly and in a timely manner.

Another shortcoming with present intrusion detection solutions is that they approach the problem of intrusion detection with a “one size fits all” solution. Such solutions characterize abnormal behavior with reference to a single threshold level that is tuned to a single, default traffic level, regardless of the size of the company or the particular data traffic characteristics. Unfortunately, the “one size fits all” solutions require extensive tuning of the IDS to reduce false positives, which increases the deployment time and cost. Further, these solutions have a fixed number of attack signatures, thereby treating all customers at the same cost/support level even if they do not need it. Finally, these conventional systems are usually targeted to a small, vendor specific group of products, and cannot identify and respond to abnormal behavior across multiple classes and multiple types of devices.

Based on the above shortcomings and inadequacies, a need exists for an Intrusion Detection and Response (IDR) system that establishes abnormal protocol/service behavior based attack signature thresholds, and that can be tailored based on the profile of an enterprise. In addition, the IDR system should be able to scan, analyze and correlate log events in near real-time, and scan not just across a single category of devices, but also across a large community of IT devices.

A further need exists for a technology solution that provides multiple distinct and complementary levels of intrusion detection to establish an effective security shield for organizations employing information technology networks.

### SUMMARY OF THE INVENTION

In view of the problems present in the related art, it is a first object of the present invention to provide an Intrusion Detection and Response (IDR) system that can collect, classify, and analyze host and network-based events in near real-time at a central collection point.

A second object of the present invention is to provide log-based Intrusion Detection and Response without requiring a software agent to be loaded on the monitored device.

A third object of the present invention is to provide an Intrusion Detection and Response system that can scan log-based events, not just across a single category of devices, but also across a large community of devices.

A fourth object of the present invention is to provide an Intrusion Detection and Response system which identifies log-based abnormal behavior by employing pre-defined templates based upon on the type/profile of an enterprise.

A fifth object of the present invention is to provide an Intrusion Detection and Response system which identifies knowledge-based attack signatures by employing pre-defined templates based upon on the type/profile of an enterprise.

A sixth object of the present invention is to provide automatic response processes to abnormal behavior or intrusion attempts.

To achieve these and other objects, the present invention provides an intrusion detection and response system having a log-based event classification system, wherein the log-based event classification system includes a log event data collection means for receiving a plurality of data sets from a respective and corresponding plurality of security devices. An event analysis means receives the plurality of data sets and analyzes the data sets with reference to one of a plurality of pre-defined traffic classes, and produces a corresponding plurality of analyzed data sets. An event correlation means receives the analyzed data sets and correlates the events across the plurality of security devices for identifying normal and abnormal data traffic patterns.

The intrusion detection and response system may also include a knowledge-based event classification system. Whether used in a log-based event classification system, a knowledge-based event classification system, or a combination of the two, the plurality of pre-defined traffic classes may be segmented based on enterprise size, historical traffic patterns, or both. The event analysis means can further analyze the plurality of data sets with reference to one of a plurality of feature sets. The feature sets may be segmented based on pre-defined and discrete numbers of attack signatures.

Using the event correlation tools, it is possible to have both real-time and historical views showing similarities between abnormal behavior across multiple diverse devices (e.g., firewalls, routers, hosts, IDS from multiple vendors) and multiple diverse and unrelated communities (i.e., many different customers).

### BRIEF DESCRIPTION OF THE DRAWINGS

The above objects and other advantages of the present invention will become more apparent by describing in detail the preferred embodiments thereof with reference to the attached drawings in which:

FIG. 1 is a schematic diagram of an exemplary hardware configuration for a log-based event classification system in accordance with an embodiment of the present invention;

FIG. 2 is an illustration of the event classification system flow process according to the present invention;

FIG. 3 is a schematic diagram of an exemplary hardware configuration for a network and host-based Intrusion Detection and Response system according to the present invention;

FIG. 4 is a schematic diagram of an exemplary hardware configuration for a combined and correlated log-based event classification system and network-based Intrusion Detection and Response system in accordance with an embodiment of the present invention; and

FIG. 5 is a flow process illustrating the detailed sub-steps of the Event Analysis Engine Process and the Event Correlation Engine Process according to the present invention.

### DETAILED DESCRIPTION OF THE PREFERRED EMBODIMENTS

The present invention will now be described more fully with reference to the accompanying drawings, in which preferred embodiments of the invention are shown. The invention may, however, be embodied in many different forms and should not be construed as being limited to the embodiments set forth herein. Rather, the embodiments are provided so that this disclosure will be thorough and complete, and will fully convey the concept of the invention to those skilled in the art.

The present invention relates to a comprehensive managed Intrusion Detection and Response (IDR) solution, combining (i) near real-time log-based monitoring employing variable behavior based attack signatures, and (ii) network/host-based intrusion detection systems that utilize knowledge-based attack signatures, with the capability to correlate security events across a variety of platforms from leading vendors.

As described above, in addition to firewalls, this managed IDR system can be used on many other security devices, such as virtual private networks (VPNs) and anti-virus applications. VPNs allow remote employees to access the corporate network by using the Internet as the transmission medium. Encryption and authentication technology and secure protocols make the network “private,” even though communication takes place over public lines.

Also, in addition to their real-time response capabilities, the present IDR system provides comprehensive incident reports that are helpful for security assessments and follow-up investigations. The reporting tools help users track and uncover patterns of network misuse and breaches of security.

The IDR system of the present invention combines a unique log-based event classification system relying on variable behavior based attack signatures, and a unique network/host-based detection system relying on knowledge-based attack signatures. The event classification system of the present invention introduces the concept of a Customer Traffic Class and Feature Set matrix. In addition, there is a correlation of an individual customer's Log/Behavior-Based Attack Signature events and the Network/Host Knowledge-Based Attack Signature events. Moreover, there is a correlation across multiple customers to more quickly spot new attack trends earlier in the new attack cycle.

Generally, the log-based event classification system will be described in detail, followed by a description of the network/host-based intrusion detection system. Then, the interaction and correlation between the two systems will be described.

Log-Based Event Classification System

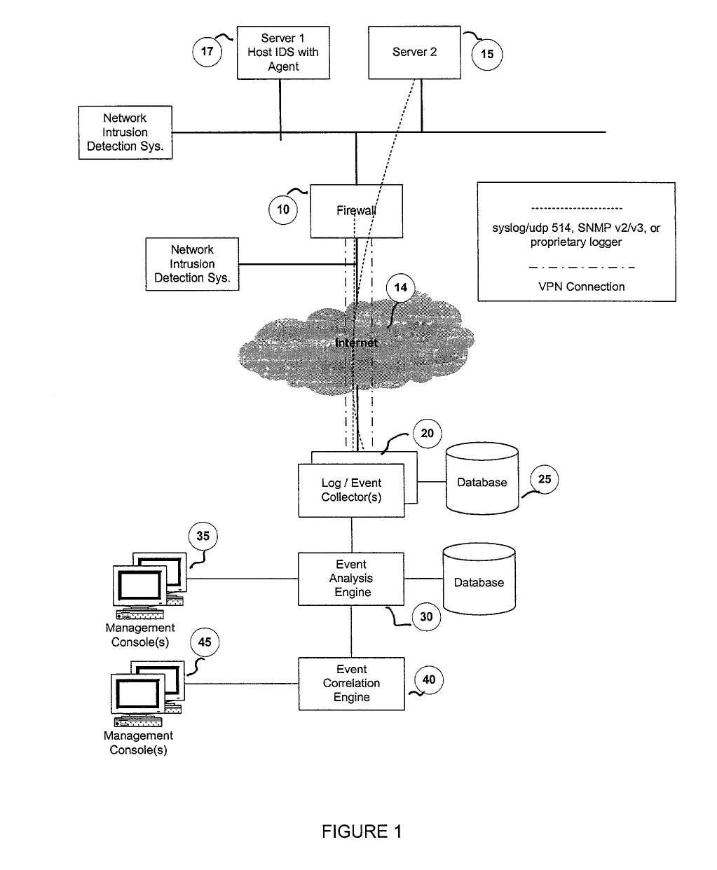

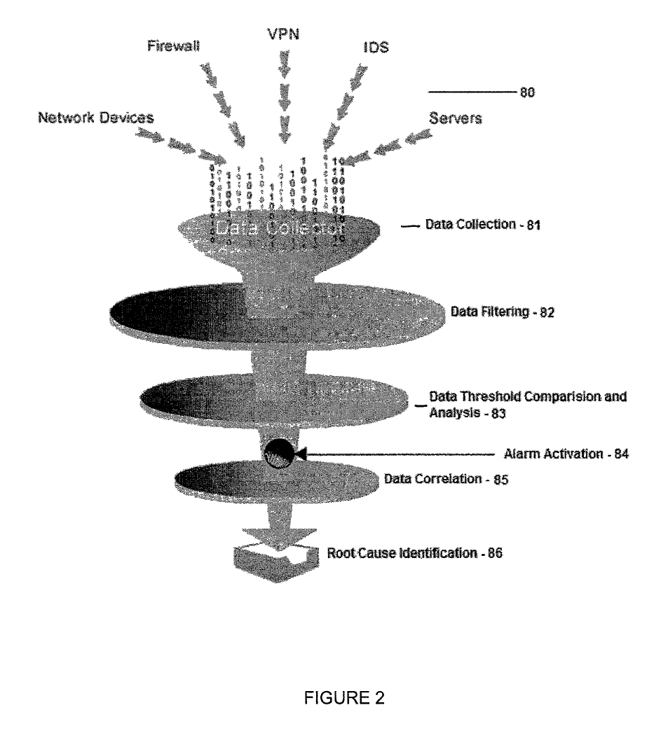

FIG. 1 is a schematic diagram of an exemplary hardware configuration for a log-based event classification system in accordance with an embodiment of the present invention, and FIG. 2 is an illustration of the event classification system flow process according to the present invention

For simplicity and ease of discussion, the discussion below is set forth with reference to a network security device consisting of a firewall. It is understood that the structure, principles and methods of the present invention may be utilized with any network or host device.

FIG. 1 illustrates the end user's firewall 10 connected to the IDR provider's system via a secure connection 14. As the log events are created on the device 15 (i.e., Server 2), copies of the log events are sent in real-time via syslog, SNMP v2/v3, or other proprietary logging method, through the secure channel 14 across the Internet to a secure central log/event collector 20, where they are collected for further processing. The log events are securely stored at the central log/event collector 20 in an associated event database 25, for example.

One example of a secure channel is an IPSec tunnel. IPSec is a suite of protocols that seamlessly integrate security features, such as authentication, integrity, and/or confidentiality, into the standard IP (internet protocol). Using the IPSec protocols, you can create an encrypted and/or authenticated communication path, depending upon the protocols used, between two peers. This path is referred to as a tunnel. A peer is a device, such as a client, router, or firewall that serves as an endpoint for the tunnel. Other suitable secure channels, such as VPNs and the like, may be used to ensure secure data transfer.

As shown in FIG. 2, the event classification system flow process 80 includes a first Data Collection process (step 81), as carried out by the log/event collector 20. The efficacy of this unique log-based event classification system is that it uses the logging ability built into all major network devices to collect the initial data. FIG. 2 illustrates exemplary devices from which data is collected, including network devices, firewalls, VPNs, IDSs, and servers. As stated above, the log-base event classification system collects real time logs from these devices using standard sysiog, SNMP v2/v3 or other native logging formats.

This collection capability provides certain advantages. First, as shown in FIG. 2, it allows for an open, multi-vendor/multi-platform approach to log collection and intrusion detection, including support for multi-vendor/multi-platform devices and application servers.

A second advantage is that no additional hardware sensors need to be purchased and placed at the end user's premises, nor does any software need to be loaded or maintained on any network device (software agents are only required for certain host based intrusion detection solutions). This reduces the cost and time to deploy a security solution.

Note that since there is no standard in the level of information or syntax used by security devices for event logging, rules and signatures must first be written specifically for each device. However, after this initial customization is accomplished, the remainder of the process is uniform.

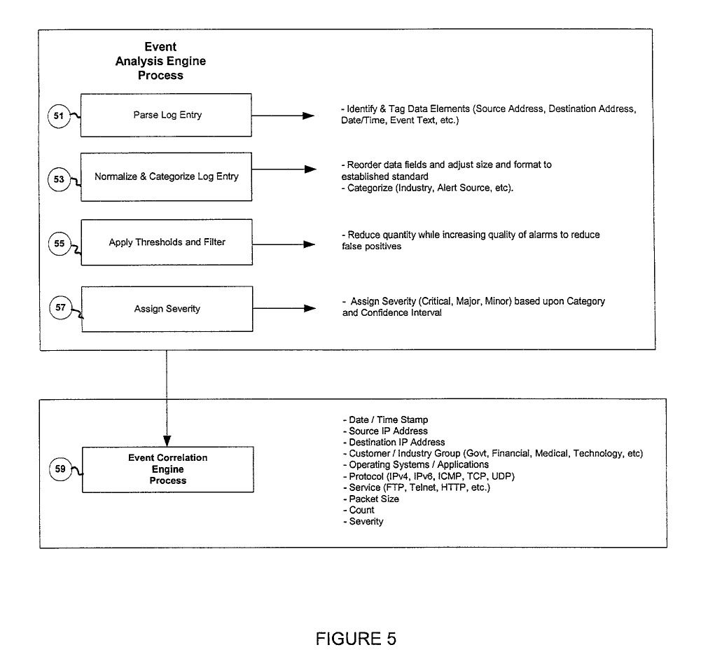

After the data collection is accomplished (step 81), the log events are processed thru an Event Analysis Engine 30 (see FIG. 1), in near real-time. FIG. 5 is a detailed flow diagram of the sub-steps of the Event Analysis Engine Process as performed by the Event Analysis Engine 30. The following will be described with reference to FIGS. 1, 2 and 5.

As set forth in FIG. 5, each event is first parsed in step 51 so that data elements are identified and tagged (e.g., Source Address, Destination Address, Date/Time, Event Text, etc.).

Then in step 53, the events are normalized against a common standard (e.g., fields re-ordered and adjusted for size, data type, format, etc.), and assigned a Category based upon origination (e.g., Industry, Alert Source, etc.).

After the normalization process, a search for a match may be conducted against a Known Offender or attack signature database. As the name implies, the attack signature database contains “known” signatures from prior and previously encountered attacks. If a “match” is found, an alert is generated.

In step 55, the events are de-duplicated and compared against established thresholds to weed out probable false positives. More specifically, after the data is collected, parsed, normalized and categorized as described above, the present invention then applies sophisticated filtering techniques (Data Filtering, step 82 in FIG. 2) to substantially streamline problem diagnosis.

Drawing on an extensive knowledge base of the particular infrastructure, and historical performance trends, the filters statistically qualify the data, and then compare the findings within the normal performance envelope (i.e., anything that is not normal must be abnormal and therefore should be qualified.) For example, in a particular service category “1000 HTTP Web Requests per minute is normal . . . however today it is 10,000 per minute . . . this is abnormal behavior and therefore suspicious”.

The accuracy of the log-based event classification system of the present invention is a function of the device visibility. Visibility is defined as adjusting (increasing or decreasing) the device logging for different types of services and/or types of traffic. It is important to strike a balance in logging, ensuring that the “right things” are being logged as opposed to logging “everything”. Quality over quantity is important to prevent wasting system and network resources. Sensitivity is also improved when only relevant services are logged. Logging levels (i.e., what to log) for traffic are established at the time of installation as described in greater detail below. It is reviewed and adjusted at regular intervals to reduce the volume while increasing the accuracy of the data.

Any application or service that travels through a security device will have a specific protocol traffic pattern, e.g., HTTP, FTP, Telnet, SQL, etc. Since typical traffic patterns differ across multiple classes or sizes of enterprises, the present invention has established “Customer Traffic Class” categories that set forth “normal” traffic patterns for a given organization's size and network behavior. For greater accuracy in detecting abnormal behavior, and to preclude “false positives”, the present invention recognizes protocol traffic patterns based upon an enterprise's business profile (e.g., small office, enterprise, high volume enterprise) before determining whether to classify the event as abnormal behavior.

Note that in accordance with the present invention, the traffic patterns are compared against multiple enterprise classes. It is understood that variations on the number of classes, and the number of users defining the class is considered within the scope of this invention. The net effect is to provide a greater degree of granularity in determining what constitutes abnormal behavior.

With the present inventive approach, not only will intruders be identified, but errant or mis-configured applications will also be identified, since both can be disruptive to an end user's business. Each event is assigned a threshold level determined by the originating device's assigned Customer Traffic Class.

For example, consider an exemplary attack scenario where two SMTP (Simple Mail Transfer Protocol) servers are transferring an excessive amount of data. For a small office (less than 5 users), greater than 50 MB transferred in a short period of time may constitute the threshold for abnormal behavior. However, for an enterprise with up to 50 users, greater than 100 MB transferred in a short period of time may constitute the threshold for abnormal behavior. Further, for a high volume enterprise with greater than 50 users, greater than 150 MB transferred in a short period of time may constitute the threshold for abnormal behavior. It is evident that the “thresholds” described herein are not hard mathematical formulas, but rather are subjective attributes based on experience and observed behavior. In addition, companies may determine their own enterprise classes, numbers of users, and attacks scenarios, and corresponding threshold values.

Table 1 below illustrates an exemplary Customer Traffic Class/Feature Set Matrix, divided along five (5) distinct Customer Traffic Classes, and three (3) distinct levels of Feature Sets.

TABLE 1
Exemplary Customer Traffic Class/Feature Set Matrix

| | Traffic Class | | | | |
|---|---|---|---|---|---|
| | | Small | | Large | |
| | Small | Enter- | Mid-Sized | Enter- | Service |
| | Office | prise | Enterprise | prise | Provider |
| Basic | B1 | B2 | B3 | B4 | B5 |
| Feature Set | | | | | |
| “7 Attack | | | | | |
| Signatures” | | | | | |
| Standard | S1 | S2 | S3 | S4 | S5 |
| Feature Set | | | | | |
| “30+ Attack | | | | | |
| Signatures” | | | | | |
| Advanced | A1 | A2 | A3 | A4 | A5 |
| “50+ Attack | | | | | |
| Signatures” | | | | | |

The values B1-B5, S1-S5, and A1-A5 represent different threshold values for abnormal behavior based on the Customer Traffic Class. As described above, the thresholds are subjective in nature, and are not defined by predetermined mathematical formulas. In other words, what is “abnormal” to one corporate provider may not be “abnormal” to another corporate provider. However, as experience is gained across different Customer Traffic Classes, over time these finely pre-tuned threshold values can be adjusted, which speeds the installation of new devices with a minimal post installation-tuning period. By proper application of this knowledge base, the accuracy is increased and the number of false positives is reduced.

After the data is filtered (step 82 in FIG. 2), a Data Threshold Comparison and Analysis step 83 is performed. Specifically, when a threshold is exceeded, an event's “degree” of abnormal behavior is automatically measured based upon the level with which the event exceeds the threshold, and over what length of time. A statistical index/confidence interval is then assigned which helps to gauge the probability of a false positive. For example, a higher degree of abnormal behavior would correspond to an event that greatly exceeds the threshold in short period of time. By contrast, a lower degree of abnormal behavior would correspond to an event that just barely exceeds the threshold over a longer period of time.

After the Data Threshold Comparison and Analysis step 83 is performed, the events are then assigned a severity (step 57 of FIG. 5) and presented to the centralized management center for further analysis and response. The severity level is based upon the event's potential level of impact, and exemplary severity levels are set forth below.

| Severity | Level of Impact |
|---|---|
| Critical | Multiple Customers, potentially affects network/service |
| | availability or stability |
| Major | Individual Customer, potentially affects network/service |
| | availability or stability. |
| Minor | Individual Customer, potentially degrades network/service |
| | performance. |
| Warning | Individual Customer, little potential for impact at this time, |
| | should be monitored |

The above-defined severity levels are subjective and modifiable in nature, and are not defined by predetermined mathematical formulas. The number and nature of the severity levels can be altered within the context of the present invention.

Other attributes of the Event Analysis Engine 30, and its determination of abnormal behavior, will now be described. Abnormal Behavior is generally defined as any traffic pattern that does not fit the normal baseline. Accepts, Drops, Rejects are analyzed for abnormal behavior based on originating and destination IP addresses, destination service, quantity of connections, amount of data transferred, etc.

The Event Analysis Engine 30 monitors for both protocol and service specific abnormal behavior signatures. Protocol abnormal behavior might be excessive TCP (transmission control procedures) session attempts from the same originating IP (internet protocol) address during a given time period. Service specific abnormal behavior might be an excessive number of port 23 (Telnet) sessions to the same destination IP address during a given time period. Abnormal could be an intrusion, an ill behaved or errant application, a traffic pattern change due to a network anomaly, or a sudden change in business environment.

Exemplary abnormal behavior patterns would include, but are not limited to:

machine scanning—scanning a network to see the machine that it contains

port scanning—scanning the ports on a machine to see the services that are running

port overuse—the abuse of a service offered by a particular machine

too many accepts, rejects or drops—for instance, users receiving persistent denial of service

oversized data transfers—for instance, excessively large FTP transfers

too many device policy changes—could indicate suspicious activity

If the behavior of a session is considered abnormal, it can be denied access across a firewall to prevent a security breach.

The Event Analysis Engine 30 also includes general protocol rule sets. These signatures take into account abnormal behavior patterns for Internet protocols such as TCP/IP, UDP and ICMP. Even if a protocol service is not defined within the log-based event classification system of the present invention, as long as it is logged, the general behavior rules will apply.

In step 84 of FIG. 2, once an abnormal condition is identified and verified, an alarm is initiated and the alarm response functions, both from a pre-programmed hardware/software perspective as well as a personnel perspective, are set in motion. Certain problems undoubtedly demand the undivided attention of a system specialist monitoring the network, while other more routine alarms can be readily handled by way of pre-programmed responses. Therefore, the proper attention can be given to a particular event, without wasting resources.

Alarms can be sent via email, pager or handheld device, and the network management platform. Alarm thresholds enable the network monitors to view critical, major and minor alarm thresholds to see exactly when and where the attribute exceeds the threshold, by how much, and for how long. At a glance, these alarm views provide real-time alerts for the entire customer base. The alarm status is presented in logical groupings, allowing the network monitors to access powerful diagnostic tools for quick root cause analysis and identification (see step 86 of FIG. 2).

Referring back to FIG. 1, after the data is processed through the Event Analysis Engine 30, it is passed to the Event Correlation Engine 40. The corresponding Data Correlation process (step 85 in FIG. 2) makes it possible to have both real-time and historical views showing similarities between abnormal behavior across multiple diverse devices (e.g., firewalls, routers, hosts, IDS from multiple vendors) and multiple diverse and unrelated communities (i.e., many different customers). These advanced tools provide both pre-defined and ad-hoc visibility into the correlation between source and destination IP's, network services, and matching or distinct patterns of abnormal behavior. This provides for rapid identification of new or changing vulnerability trends.

As set forth in FIG. 5, the Event Correlation Engine Process 59 enables correlation of multiple abnormal events over time, as described in the following examples:

Same originating IP address/IP subnet (individual or group of compromised hosts) attacking multiple TCP Services (http, telnet, ftp, etc.) across multiple devices on a customers' network.

Same originating IP address/IP subnet (individual or group of compromised hosts) attacking same TCP Service (TCP port 2347) across multiple distinct customer networks.

Repetitive series of abnormal behavior attempts (e.g., excessive http outbound, abnormal number of calls to IRC service requests outbound, excessive SMTP failed requests) across multiple distinct customer networks.

The Event Correlation Engine 40 enables both real-time and historical views showing similarities between abnormal behavior across multiple diverse devices (e.g., firewalls, routers, hosts, IDS from multiple vendors) and multiple diverse and unrelated communities (i.e., many different customers). The centralized security management team can use these advanced tools to present correlations using predefined templates or ad-hoc searches for correlation between source and destination IP's, network services, and matching of distinct patterns of abnormal behavior. This provides the ability to quickly identify new or changing vulnerability trends.

In summary, as described above, the log-based event classification system of the present invention includes a unique set of protocol and service based attack signatures. This is advantageous since it allows the log-based event classification system to see activity missed by knowledge-based network and host IDS implementations, because the latter two require a regularly updated list of known attacks, just like anti-virus software.

Intrusion detection tools that use knowledge-based signatures look for very specific, known vulnerable data patterns. Examples would be known buffer overflows, parsing errors, malformed URL's, etc. Because they match on known vulnerabilities, there is a delay between the time a new vulnerability is “in the wild” and when a signature can be developed, tested and released. Because the log-based event classification system of the present invention uses behavior-based signatures, it has the advantage of detecting attempts to exploit new unforeseen vulnerabilities. This actually helps contribute to the discovery of new attacks. It can also help detect “abuse of privilege” attacks that do not actually involve exploiting a security vulnerability.

Network/Host Based Intrusion Detection System

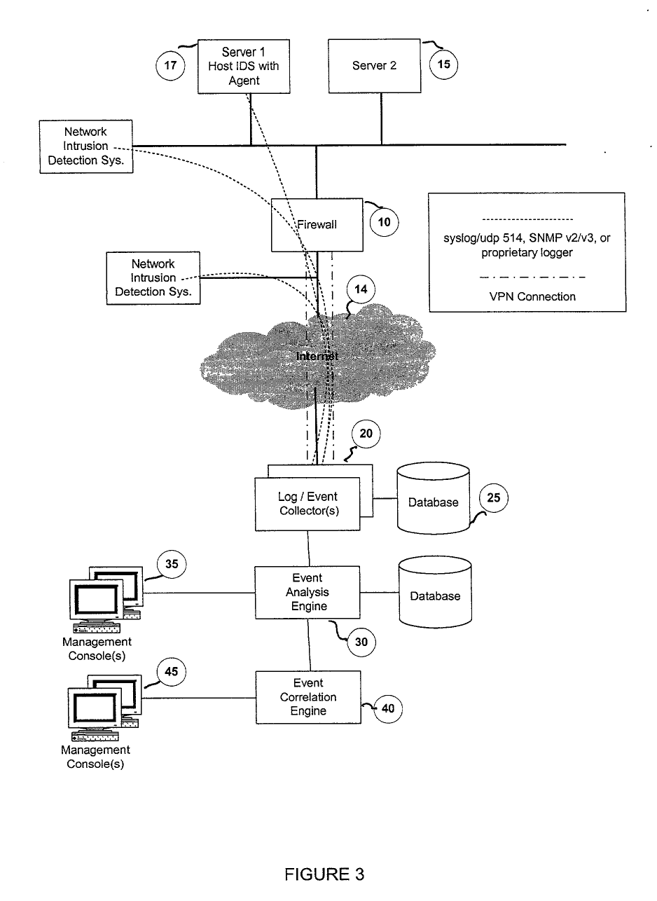

FIG. 3 is a schematic diagram of an exemplary network/host based hardware configuration.

Network-based systems inspect the payload of all packets on the attached network segment matching for known patterns of exploits that pass the wire. This would include but is not limited to known buffer overflows, parsing errors, malformed URL's, and DDoS (distributed denial of service) attacks.

Host-based systems can inspect both network data and audit system logs for suspicious activity on the target host. Host-based inspection is particularly important for traffic that may have been encrypted while in transport on the network. Host-based systems use software “agents” that are installed on the servers and report activity to a central console collection point. Host-based agents can be configured to automatically respond to intrusion attempts before they have a chance to do any damage. Responses might include: (i) kill or reset malicious TCP connections; or (ii) execute any user-defined programs or batch files.

FIG. 3 illustrates the end user's firewall 10 connected to the IDS provider's system via a secure connection 14. An exemplary host-based system 17 employs an agent to inspect data associated with Server 1. Regardless of whether a network-based or host-based system is used, copies of the data are sent in real-time via syslog, SNMP v2/v3, or other proprietary logging method, through the secure channel 14 across the Internet to the secure central log/event collector 20, where they are collected for further processing as described with respect to FIG. 1.

A network-based system will employ network sensors to “sniff” the wire, comparing live traffic patterns to a list of known attack patterns. The sensor will only see traffic on the local network segment where it is attached since routers, switches and firewalls will prevent traffic from be copied to inappropriate segments. The best rule is to place a sensor on each segment where there is critical data to protect or a set of users that should be monitored. Examples include: (i) outside the firewall, between the DMZ and the Internet; (ii) just inside the firewall to detect unauthorized activity from the Internet that makes it through the firewall; (iii) any segment where there is dial-up access; (iv) at an extranet, since it extends the network perimeter, and traffic is particularly sensitive with added vulnerability due to a lack of total control of connectivity; and (v) any important internal segment to protect vital data.

The sensor has an extensive, and regularly updated, attack signature database of known threats. These threats include: (i) denial of service (DOS) attacks (e.g., SYN Flood, WinNuke, LAND); (ii) unauthorized access attempts (e.g., Back Orifice or brute force login); (iii) pre-attack probes (e.g., SATAN scans, stealth scans, connection attempts to non-existent services); (iv) attempts to install backdoor programs (e.g., rootkit or BackOrifice); and (v) attempts to modify data or web content and other forms of suspicious activity (e.g., TFTP traffic).

Network-based system sensors can be configured to automatically respond to intrusion attempts before they have a chance to do any damage. Responses might include: (i) kill or reset malicious TCP connections; (ii) block offending IP address's on firewalls; or (iii) execute any user-defined programs or batch files.

A typical sensor has an active and passive interface. The passive interface resides on the network to be protected, and the active interface resides on the management network. Each sensor has a policy that defines what it will and will not look for. Every network is different and some traffic in moderation is acceptable. The sensor must learn what is, and is not, acceptable traffic on any given segment. This period of adjustment is often referred to as the tuning or footprint period. The tuning process can take anywhere from 2 to 6 weeks depending on the complexity of a given network.

The Log/Event Collector 20 is the central collection point for the multiple network sensors 50. It maintains a database 25 of all alerts for historical research and reporting.

The Management Console 35 interacts with the Event Analysis Engine 30, and functions as a centralized management and reporting station that controls the remote sensors. Sensor policy and signature updates are pushed from the Management Console 35. It is also used as an advanced diagnostic and troubleshooting interface. As the tuning process takes place, operators will make adjustments to the sensors with this interface. This provides a centralized point of administration for potentially a vast array of sensors with different requirements. The sensors attack signature database is typically updated as quickly as possible after test and acceptance of a new attack signature. The Management Console 45 provides a similar operational, diagnostic, and troubleshooting interface to the Event Correlation Engine 40.

As with the log-based system described in FIG. 1, the Event Analysis Engine 30 receives the event data from the Log/Event Collector 20, and processes each event in accordance with the Event Analysis Engine Process flow 51, 53, 55, 57, as described previously with reference to FIG. 5.

By way of brief summary, the event data is parsed, normalized, and then categorized. When a threshold is exceeded, an event's “degree” of abnormal behavior is automatically measured based upon the level with which the event exceeds the threshold and over what length of time. A statistical index/confidence interval is assigned which helps to gauge the probability of a false positive. Events are then assigned a severity and presented to the centralized management center for further analysis and response. The severity level is based upon the event's potential level of impact as described previously.

The event data is then processed in accordance with step 84 (alarm activation), step 85 (data correlation), and step 86 (root cause identification) as described with regard to FIG. 2.

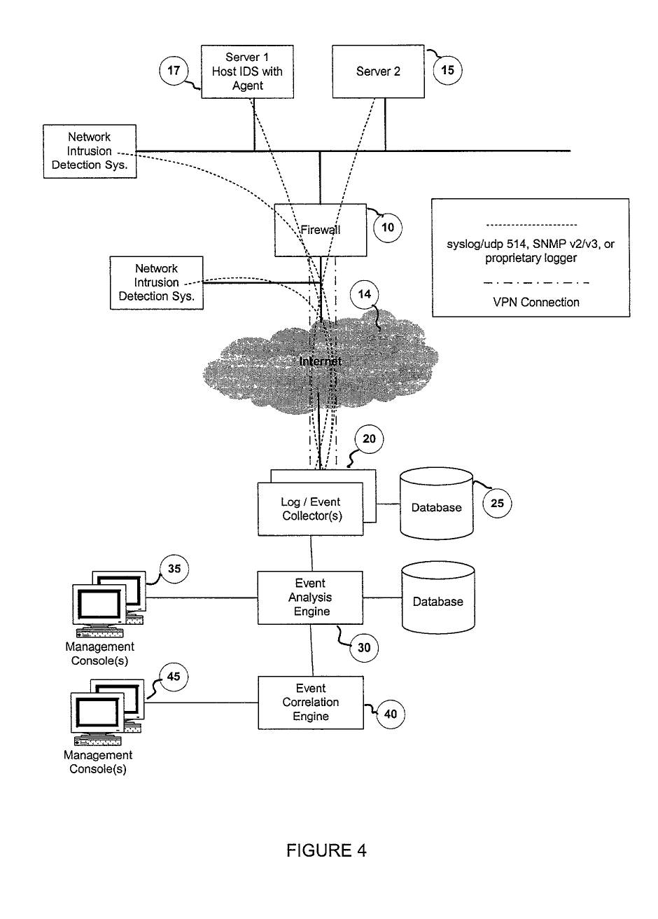

FIG. 4 is a schematic diagram of an exemplary hardware configuration for a combined and correlated log-based event classification system and network-based Intrusion Detection and Response system in accordance with an embodiment of the present invention. FIG. 4 is in effect a combination of FIG. 1 and FIG. 3, wherein the same reference numerals designated the same elements. For simplicity, the physical structure and log/event data flow processes will not be repeated here. It is understood that the physical structure and log/event data flow of FIG. 1 and FIG. 3 occur simultaneously.

The primary benefit of the Event Correlation engine is time. Using pre-defined templates the central security management team can more quickly identify new or changing vulnerability trends. Less time to detect and isolate, thus providing faster response.

The advantages of the log-based event classification system and the network/host based detection systems have been described as above. However, it is not a question of which detection system is better—both look at traffic in different ways and have different cost structures, and both can play an important and synergistic role in an enterprise's security architecture.

The most common value scenario of using correlation of log-based IDS and knowledge-based IDS is when a customer's systems are targeted with either a new exploit for which there is currently no attack signature in the Network IDS's knowledge database, or a variant of a known exploit. In such a situation, the abnormal behavior is seen (e.g., excessive http or ssh requests) by the log-based IDS. The log-based IDS event is correlated (e.g., time, source, destination, service, etc.) against the knowledge-based IDS data. The lack of any knowledge-based IDS data may indicate a new exploit. The presence of knowledge-based IDS data, but non-matching log-based IDS Abnormal Behavior, usually indicates a variant of a known exploit (e.g., nimda vs. Code Red).

It is possible to use correlation to see new multi-variant attack signatures earlier in the attack cycle. Similar, seemingly unrelated, abnormal behavior repeated several times across multiple unrelated networks would prompt operators to investigate further, and perhaps eliminate or mitigate an otherwise unsuspected or undetected attack.

An exemplary attack might comprise excessive outbound http requests from a Web Server, an abnormal amount of NetBIOS activity, and a sudden increase in outbound e-mail activity—all occurring within a 10 to 15 minute time frame. This abnormal behavior would have been an early indication of a network infected with the nimda worm even before an attack signature could be developed.

As alluded to previously, the combination of the log-based and knowledge-based systems provides synergistic advantages, which are described below. These advantages are especially apparent in view of the novel thresholding and filtering techniques of the present invention, which drastically reduce the number of false positives. This in turn reduces both the cost and time to deploy an effective intrusion detection solution.

Log-based systems see the abnormal behavior of an intruder's sessions as they scan and attack a network, and they are capable of identifying protocol and traffic anomalies that knowledge-based systems would ignore. Log-based systems can thus see a new exploit before it has been classified and loaded onto a knowledge-based sensor.

At the firewall, in its role as a gateway, log-based systems see all traffic traversing the network, including traffic that is dropped at the firewall. Therefore, correlations can be made and action can be taken on a suspicious IP address prior it to penetrating a network. Because log-based systems see anomalous traffic patterns, they can help detect “abuse of privilege” attacks that don't actually involve exploiting a security vulnerability.

For log-based systems, no special hardware sensors or software need to be loaded on servers. This lowers the cost and leverages the investment already made in security devices such as firewalls. The lower cost allows wider deployment of IDS functionality within an enterprise's network infrastructure.

On the other hand, knowledge-based systems apply the signature knowledge accumulated about specific attacks and system vulnerabilities to detect intrusions. Any traffic that is not recognized as a known exploit is considered acceptable. Accordingly, the knowledge-based system has visibility into traffic that, based upon security policy, is allowed to tunnel through the firewall into your corporate internal network.

Knowledge-based systems can be deployed within an enterprise's Intranet to see traffic that does not pass through a firewall or security device, thus having visibility that a log-based implementation would not.

The log-based and knowledge-based systems complement each other. Since log-based systems have a lower cost, they can be deployed widely, while the knowledge-based system can be deployed where the threat or information sensitivity is greatest.

While the present invention has been described in detail with reference to the preferred embodiments thereof, it should be understood to those skilled in the art that various changes, substitutions and alterations can be made hereto without departing from the scope of the invention as defined by the appended claims.

What is claimed is:

1. An intrusion detection and response system comprising a log-based event classification system, the log-based event classification system comprising:
a log event data collection means for receiving a plurality of data sets from a respective and corresponding plurality of security devices;
an event analysis means for receiving the plurality of data sets and analyzing the data sets with reference to one of a plurality of pre-defined traffic classes, and producing a corresponding plurality of analyzed data sets; and
an event correlation means for receiving the analyzed data sets and correlating events across the plurality of security devices for identifying normal and abnormal data traffic patterns.

2. The system of claim 1, wherein the plurality of pre-defined traffic classes are segmented based on enterprise size.

3. The system of claim 1, wherein the plurality of pre-defined traffic classes are segmented based on historical data traffic patterns.

4. The system of claim 1, wherein the plurality of pre-defined traffic classes are segmented based on enterprise size and historical data traffic patterns.

5. The system of claim 1, wherein the event analysis means further analyzes the plurality of data sets with reference to one of a plurality of feature sets.

6. The system of claim 5, wherein the plurality of feature sets are segmented based on pre-defined and discrete numbers of attack signatures.

7. The system of claim 1, wherein the event analysis means comprises means for comparing the plurality of data sets against a discrete threshold corresponding to a normal data traffic pattern for the pre-defined traffic class.

8. The system of claim 1, wherein the log event data is generated by a respective log event generator native to each of the plurality of security devices.

9. An intrusion detection and response system comprising a knowledge-based event classification system, the knowledge-based event classification system comprising:
an event data collection means for receiving a plurality of data sets from a respective and corresponding plurality of security devices;
an event analysis means for receiving the plurality of data sets and analyzing the data sets with reference to one of a plurality of pre-defined traffic classes, and producing a corresponding plurality of analyzed data sets; and
an event correlation means for receiving the analyzed data sets and correlating events across the plurality of security devices for identifying normal and abnormal behavior patterns.

10. The system of claim 9, wherein the plurality of pre-defined traffic classes are segmented based on enterprise size.

11. The system of claim 9, wherein the plurality of pre-defined traffic classes are segmented based on historical data traffic patterns.

12. The system of claim 9, wherein the plurality of pre-defined traffic classes are segmented based on enterprise size and historical data traffic patterns.

13. The system of claim 9, wherein the event analysis means further analyzes the plurality of data sets with reference to one of a plurality of feature sets.

14. The system of claim 13, wherein the plurality of feature sets are segmented based on pre-defined and discrete numbers of attack signatures.

15. The system of claim 1, wherein the event analysis means comprises means for comparing the plurality of data sets against a discrete threshold corresponding to a normal data traffic pattern for the pre-defined traffic class.

16. The system of claim 9, wherein the event data is generated by a sensor positioned on a portion of a network.

17. The system of claim 9, wherein the event data is generated by a software agent resident on each of the plurality of security devices.

18. An intrusion detection and response system comprising a combined log-based and knowledge-based event classification system, the event classification system comprising:
an event data collection means for receiving a plurality of data sets from a respective and corresponding plurality of security devices;
an event analysis means for receiving the plurality of data sets and analyzing the data sets with reference to one of a plurality of pre-defined traffic classes, and producing a corresponding plurality of analyzed data sets; and
an event correlation means for receiving the analyzed data sets and correlating events across the plurality of security devices, and across the log-based and knowledge-based event classification systems, for identifying normal and abnormal data traffic patterns.

19. The system of claim 18, wherein the plurality of pre-defined traffic classes are segmented based on enterprise size.

20. The system of claim 18, wherein the plurality of pre-defined traffic classes are segmented based on enterprise size and historical data traffic patterns.

21. The system of claim 18, wherein the event analysis means further analyzes the plurality of data sets with reference to one of a plurality of feature sets.

22. The system of claim 21, wherein the plurality of feature sets are segmented based on pre-defined and discrete numbers of attack signatures.

23. The system of claim 18, wherein the event analysis means comprises means for comparing the plurality of data sets against a discrete threshold corresponding to a normal data traffic pattern for the pre-defined traffic class.

24. An intrusion detection and response process, comprising:
collecting a plurality of data sets from a respective and corresponding plurality of security devices;
analyzing the data sets with reference to one of a plurality of pre-defined traffic classes, and producing a corresponding plurality of analyzed data sets; and
correlating events of the analyzed data sets across the plurality of security devices for identifying normal and abnormal data traffic patterns.

25. The process of claim 24, further comprising segmenting the plurality of pre-defined traffic classes based on enterprise size.

26. The process of claim 24, further comprising segmenting the plurality of pre-defined traffic classes based on historical data traffic patterns.

27. The process of claim 25, further comprising analyzing the plurality of data sets with reference to one of a plurality of feature sets.

28. The process of claim 27, further comprising segmenting the feature sets based on pre-defined and discrete numbers of attack signatures.

29. The process of claim 24, wherein the plurality of data sets are generated from a log event generator native to each of the plurality of security devices

30. The process of claim 29, wherein the plurality of data sets are generated from a sensor positioned on a portion of a network.

31. The process of claim 30, wherein the plurality of data sets are generated by a software agent resident on each of the plurality of security devices.
